(19) United States
(12) Patent Application Publication
(10) Pub. No.: US 2005/0282017 A1
(43) Pub. Date: Dec. 22, 2005

(54) Composite structure having a styrenated polyester layer and a filled backing layer

(76) Inventor: Joseph Jibrail, Canton, GA (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 10/874,108

(22) Filed: Jun. 22, 2004

(51) Int. Cl. B32B 27/00

(52) U.S. Cl. 428/423.1

(57) ABSTRACT

A composite structure includes a first layer, comprising a styrenated polyester, and a second layer. The first layer is a show surface of the composite structure. The second layer includes a filler and the reaction product of a resin component and an isocyanate component. The resin component includes a an isocyanate-reactive component and a supplemental cross-linking agent. The supplemental cross-linking agent is present in an amount of at least 10 parts by weight based on the total weight of the resin component for lowering a viscosity of the resin component and for controlling the reaction rate and reaction temperature of the second layer.

### FIELD OF THE INVENTION

The present invention generally relates to a composite structure including a first layer, which is a show surface of the composite structure, and a second layer. More specifically, the first layer includes a styrenated polyester. The second layer is the reaction product of an isocyanate component and an isocyanate-reactive component and includes a filler. The composite structure is primarily utilized in the kitchen and bathroom industries.

### BACKGROUND OF THE INVENTION

Use of composite structures throughout the kitchen and bathroom industries for countertops and vanities is known in the art. As is also known in the art, prior art composite structures include those having a first layer, or show surface, commonly referred to as a styrenated polyester layer, and a second layer, commonly referred to as a styrenated polyester resin backing layer. The backing layer functions to provide support and durability to the complete composite article.

It is also known in the art that, during application of the first and second layers to a mold substrate, large quantities of styrene monomers, which are considered volatile organic compounds (VOCs), are emitted which is undesirable for environmental, health, and safety reasons. As a result of the quantities of styrene monomers associated with the composite structures of the prior art, the industry has sought to eliminate certain layers in the composite structures that include styrene.

In response to the need outlined above, the industry is moving toward composite structures that have the same first layer described above but a different second layer. This different second layer is a polyurethane or polyurea backing layer. However, the composite articles of the prior art that already include a polyurethane or polyurea backing layer as the second layer are deficient for various reasons.

Generally, the polyurethane and polyurea backing layers of the prior art, when used in combination with a styrenated polyester layer, “set-up” or react too quickly. For instance, when the backing layer, i.e., the polyurethane or polyurea layer, is applied to the first layer, i.e., to the styrenated polyester layer, cross-linking is necessary between the polyurethane or polyurea backing layer and the styrenated polyester layer for adhering the backing layer to the first layer. The polyurethane and polyurea backing layers do not sufficiently cross-link with the styrenated polyester layer when the reaction is too quick. Ultimately, the bond between the polyurethane and polyurea backing layers and the styrenated polyester layer is unacceptable because there is insufficient cross-linking between the layers. Thus, it is important to adjust types and amounts of various components in the polyurethane and polyurea backing layers to slow the reaction. More specifically, the types and amounts of polyol or polyamine and supplemental cross-linking agent must be adjusted to regulate the reaction. The publication entitled “The Versatility of UOP Unilink and Clearlink Diamines in Polyurethane and Polyurea Systems” to House et al. (the Unilink publication) discloses polyurethane and polyurea layers including supplemental cross-linking agents optimized for slowing the reaction to increase gel time of the backing layer.

The Unilink publication fails to disclose polyurethane and polyurea backing layers including fillers, which provide pigmentation and reduce the cost of the composite structure. More specifically, the prior art does not disclose filled polyurethane and polyurea backing layers that are optimized for gel time and reaction temperature in view of different reaction variables that would result from the presence of fillers in the backing layers. In particular, the fillers slow the reaction and thus substantially increase gel time to an extent that the reaction of the prior art polyurethane and polyurea backing layers is too slow. The fillers also increase the viscosity of polyurethane and polyurea backing layers, making the backing layers difficult to spray and/or pour. In addition, elevated reaction temperatures are required to cure the polyurethane and polyurea backing layers, as a result of the presence of the fillers, while minimizing damage to the styrenated polyester layer.

The polyurethane and polyurea backing layers of the prior art have not, to date, been optimized for use with styrenated polyester layers by optimizing the amount and type of the particular polyols, polyamines, supplemental cross-linking agents, and fillers utilized in the backing layer. More specifically, the polyurethane and polyurea backing layers have not been optimized to lower the increased viscosity resulting from the presence of the filler in the backing layers. Furthermore, the elevated reaction temperature required to cure the second layer as a result of the presence of the filler has not been addressed, and the components have not been optimized to achieve the elevated reaction temperature without increasing the reaction rate and without blistering or cracking the finish of the styrenated polyester layer.

Due to the deficiencies in the composite structures of the prior art, including those described above, it is desirable to provide a novel and durable composite structure having a styrenated polyester layer backed by a filled polyurethane or polyurea backing layer that has sufficiently low viscosity to allow the backing layer to be sprayed and/or poured, reacts in a controlled manner and at an elevated temperature to cure the second layer and allow adequate time for cross-linking and adhesion to occur between the styrenated polyester layer and the backing layer without affecting the finish of the styrenated polyester layer.

### SUMMARY OF THE INVENTION

A composite structure is disclosed. The composite structure of the subject invention includes a first layer and a second layer. The first layer includes a styrenated polyester and is a show surface of the composite structure. The second layer includes a filler and the reaction product of an isocyanate component and a resin component reactive with the isocyanate component. The resin component includes an isocyanate-reactive component and a supplemental cross-linking agent. The supplemental cross-linking agent is present in an amount of at least 10 parts by weight based on the total weight of the resin component.

The amount of supplemental cross-linking agent in the resin component of the second layer functions to lower a viscosity of the second layer and elevate a reaction temperature of the second layer, as compared to a reaction temperature absent the supplemental cross-linking agent. The elevated temperature, required as a result of the presence of the filler, cures the second layer. The amount of supplemental cross-linking agent also controls the reaction rate of the second layer to provide adequate time for cross-linking and adhesion to occur between the styrenated polyester layer and the second layer without blistering or cracking the finish of the styrenated polyester layer.

### DETAILED DESCRIPTION OF A PREFERRED EMBODIMENT

A composite structure according to the subject invention includes a first layer and a second layer. Ultimately, the first layer is a show surface of the composite structure. The second layer is a backing layer for providing support and durability to the first layer of the complete composite structure.

Preferably, the first layer and the second layer are applied to a mold substrate in an open-mold process to form the composite structure. However, it is to be appreciated that the first layer and second layer may be applied in a closed mold to form the composite structure. In the open-mold process, the first layer is sprayed or poured onto a surface of the mold substrate, and then the second layer is sprayed or poured onto the first layer without the mold substrate having to close upon itself to form the composite structure. The first layer and the second layer are then de-molded from the open mold substrate. After application of the first layer and the second layer, and also after the de-molding of the completed composite structure, the first layer is a show surface of the composite structure whereas the second layer is a support or backing layer to the first layer.

The first layer includes a styrenated polyester. Preferably, the styrenated polyester of the first layer has a nominal styrene content of at least 35 parts by weight based on the total weight of the styrenated polyester. In one preferred embodiment, the nominal styrene content of the styrenated polyester is 42 parts by weight. The styrenated polyester is formed from phthalic acid and an organic compound. The organic compound comprises a plurality of hydroxyl groups. The phthalic acid is most preferably isophthalic acid and the organic compound is most preferably an alcohol. Available hydrogen atoms from the isophthalic acid are replaced with an organic group of the alcohol to form the polyester. One styrenated polyester suitable for use in the subject invention is commercially available as Vipel™ F737-FB Series Polyester Resin (formerly E737-FBL) from AOC Resins of Collierville, Tenn.

The second layer includes a filler and the reaction product of an isocyanate component and a resin component reactive with the isocyanate component. The resin component more specifically includes an isocyanate-reactive component and a supplemental cross-linking agent. The presence of the filler in the second layer causes a relative amount of the isocyanate-reactive component, preferably a polyol or polyamine, in the support layer and the resin component to be diluted, as compared to the amount of isocyanate-reactive component in the resin component and in the support layer without the filler. Thus, the isocyanate component and the isocyanate-reactive component are more disperse in the support layer given the presence of the filler. As a result, an elevated reaction temperature is required to increase the reactivity between the isocyanate component and the isocyanate-reactive component. The supplemental cross-linking agent functions to lower a viscosity of the second layer and to elevate a reaction temperature of the second layer, as compared to a reaction temperature absent the supplemental cross-linking agent. As such, the existence of the supplemental cross-linking agent enables the elevated reaction temperature to be attained.

The supplemental cross-linking agent, to be described further below, lowers a viscosity of the resin component and, more specifically, the second layer by producing short chain links with the isocyanate component. Preferably, the viscosity of the second layer is from 10 to 10,000 centipoise at 75 deg. F. More preferably, the viscosity is from 200 to 1500 centipoise at 75 deg. F. As a result of the lower viscosity of the second layer, the second layer is sprayable and/or pourable during production of the composite structure.

The supplemental cross-linking agent also functions to elevate a reaction temperature of the second layer as compared to a reaction temperature absent the supplemental cross-linking agent. Preferably, the reaction temperature is from 90 to 350 deg F. More preferably, the reaction temperature is from 150 to 220 deg F. The elevated reaction temperature, required as a result of the presence of the filler, cures the second layer such that cross-linking occurs within the second layer.

In one embodiment, the supplemental cross-linking agent includes a hydroxy-functional cross-linking agent. Suitable hydroxy-functional cross-linking agents include, but are not limited to, ethylene glycol, propylene glycol, 1,4-butanediol, 1,6-hexanediol, 1,3-propanediol, 1,10-decanediol, o-, m-, and p-dihydroxycyclohexane, diethylene glycol, dipropylene glycol, bis(2-hydroxyethyl)hydroquinone, and even triols such as 1,2,4- and 1,3,5-trihydroxycyclohexane, glycerol, and trimethylolpropane, and mixtures thereof. Preferably, the hydroxy-functional cross-linking agent is a glycol selected from the group of ethylene glycols, propylene glycols, butylene glycols, and combinations thereof. Most preferably, the hydroxy-functional cross-linking agent is selected from the group of ethylene glycol, diethylene glycol, triethylene glycol, propylene glycol, dipropylene glycol, tripropylene glycol, butylene glycol and combinations thereof. However, it is to be appreciated that other hydroxy-functional cross-linking agents are possible so long as the agents are compatible with the isocyanate-reactive components and include more than one hydroxy group for enabling cross-linking within the second layer.

In another embodiment, the supplemental cross-linking agent includes an amine-functional cross-linking agent. Suitable amine-functional cross-linking agents include but are not limited to aromatic diamines, aliphatic diamines, and 3,3′-di- and/or 3,3′-, 5,5′-tetraalkyl-substituted diaminodiphenyl-methanes. Preferably, the amine-functional cross-linking agent is selected from the group of aromatic diamines, aliphatic diamines, and combinations thereof. Examples of aromatic diamines suitable for use in the subject invention include dimethylthiotoluenediamine (DMTDA), diethyltoluenediamine (DETDA), and Unilink® 4200 aromatic diamine commercially available from Dorf Ketal of Stafford, Tex. An example of an aliphatic diamine suitable for use in the subject invention is Clearlink® 1000 aliphatic diamine also commercially available from Dorf Ketal. It is to be appreciated that other amine-functional cross-linking agents are possible so long as the agents are compatible with the isocyanate-reactive components and include more than one reactive amine group. Examples of suitable amine-functional cross-linking agents include hydrazine, ethylene diamine, isophorone diamine (IPDA), 4,4′-methylene-bis(2-chloroaniline) (MOCA), 4-chloro 3,5-diamino-benzoic acid isobutylester (CDABE), trimethyleneglycol-di-p-aminobenzoate (TMGDAB), 4,4′-methylene-bis-(3-chloro-2,6-diethylaniline) (M-CDEA), and combinations thereof.

The supplemental cross-linking agent is present in an amount of at least 10 parts by weight, preferably from 10 to 50 parts by weight, based on the total weight of the resin component for cross-linking the isocyanate component and the isocyanate-reactive component. More preferably, the supplemental cross-linking agent is present in an amount of at least 15 parts by weight based on the total weight of the resin component to control the reaction rate of the second layer to provide adequate time for cross-linking to occur between the styrenated polyester layer and the second layer yet maintaining the gel time such that the reaction of the isocyanate component, the isocyanate-reactive component, and the supplemental cross-linking agent is sufficiently quick to alleviate detrimental impact of the gel time on production economy. More specifically, the second layer of the composite structure has a gel time of from 0.5 to 6 minutes. In a most preferred embodiment, the supplemental cross-linking agent is present in an amount of at least 20 parts by weight based on the total weight of the resin component to produce gel times within the above stated range.

The filler in the second layer provides pigmentation and reduces the cost of the composite structure because it typically costs less than the other components in the second layer. The filler is preferably incorporated into the resin component, however, it is possible to incorporate the filler into the isocyanate component. Preferably, the filler is present in an amount of from 1 to 70 parts by weight based on the total weight of the resin component. In a more preferred embodiment, the filler is present in an amount of from 30 to 40 parts by weight based on the total weight of the resin component. Fillers such as organic, inorganic and reinforcing fillers are feasible for the subject invention. Specific examples include inorganic fillers such as siliceous minerals, for example, sheet silicates such as antigorite, serpentine, hornblends, amphiboles, chrysotile, zeolites, talc; metal oxides, such as kaolin, aluminum oxides, titanium oxides and iron oxides, meta salts, such as chalk, barite, aluminum silicates and inorganic pigments such as cadmium sulfide, zinc sulfide, and also glass particles. Examples of organic fillers include carbon black, melamine, rosin, cyclopentadienyl resins. The organic and inorganic fillers can be used individually or as mixtures. In a preferred embodiment, the filler is selected from the group of silica, aluminum hydroxide, calcium carbonate, sand, titanium dioxide and combinations thereof.

As set forth above, the resin component includes an isocyanate-reactive component. Preferably, the isocyanate-reactive component is present in an amount of from 18 to 70 parts by weight based on the total weight of the resin component. More preferably, the isocyanate-reactive component is present in an amount of from 18 to 40 parts by weight based on the total weight of the resin component. In one embodiment, the isocyanate-reactive component is a polyol. Preferably, the polyol includes an ethylene oxide cap of at least 15 parts by weight based on the total weight of alkylene oxides in the polyol. However, it is most preferred that the polyol include an ethylene oxide cap of 100 parts by weight based on the total weight of alkylene oxides in the polyol. That is, although the polyol may include some percentage of a propylene oxide cap, it is most preferred that the percentage of propylene oxide cap, based on the total weight of alkylene oxides in the polyol, is zero.

In an embodiment wherein the filler is present in an amount of at least 30 parts by weight based on the total weight of the resin component, the ethylene oxide cap is preferably present in an amount of at least 45 parts by weight based on the total weight of alkylene oxides in the polyol for increasing the reaction rate to produce gel times within the above stated range of from 0.5 to 6 minutes.

Other physical properties of the polyol of the resin component include a hydroxyl number and a nominal functionality. Preferably, the polyol has a hydroxyl number of at least 28 mg KOH/gm and a nominal functionality of at least 2.0. More preferably, the polyol has a hydroxyl number of from 28 to 510 mg KOH/gm and a nominal functionality of from approximately 2.0 to approximately 7.0. By nominal functionality, it is meant that the functionality is based upon the functionality of the initiator molecule, rather than the actual functionality of the polyol after manufacture.

Although polyether polyols are preferred, the polyol may be either a polyether polyol, a polycaprolactone polyol, or a polyester polyol. The polyol is formed from an initiator compound. Preferably, the initiator compound comprises at least one of glycerin, monoethanolamine, ethylene glycol, and toluenediamine. More generally, the initiator compound comprises low molecular weight di-, tri-, and poly-functional alcohols or polyamines, including primary and secondary amines. Other initiator compounds are possible so long as the properties for the polyol are satisfied as described above.

Suitable polyols for the resin component include, but are not limited to, phthalic anhydride-initiated polyester polyols, aromatic amine-initiated polyols, aliphatic amine-initiated polyols, polyoxyalkylene polyether polyols, polythioether polyols, polyester amides and polyacetals containing hydroxyl groups, aliphatic polycarbonates containing hydroxyl groups, amine terminated polyoxyalkylene polyethers, polyester polyols, other polyoxyalkylene polyether polyols, and graft dispersion polyols, and combinations thereof. Examples of suitable polyols having a sufficient ethylene oxide cap, as set forth above, include, but are not limited to, PLURACOL® E600, PLURACOL® 380, PLURACOL® 593, PLURACOL® 598, PLURACOL® 628, PLURACOL® 735, PLURACOL® 816, PLURACOL® 824, PLURACOL® 922, PLURACOL® 945, PLURACOL® 953, PLURACOL® 1016, PLURACOL® 1026, PLURACOL® 1062, PLURACOL® 1076, PLURACOL® 1123, PLURACOL® 1132, PLURACOL® 1158, and PLURACOL® 1168 which are commercially available from BASF Corporation.

Included among the polyoxyalkylene polyether polyols are polyoxyethylene polyols, polyoxypropylene polyols, polyoxybutylene polyols, polytetramethylene polyols, and block copolymers, for example combinations of polyoxypropylene and polyoxyethylene poly- 1,2-oxybutylene and polyoxyethylene polyols, poly- 1,4-tetramethylene and polyoxyethylene polyols, and copolymer polyols prepared from blends or sequential addition of two or more alkylene oxides. The polyoxyalkylene polyether polyols may be prepared by any known process such as, for example, the process disclosed by Wurtz in 1859 and Encycloipedia of Chemical Technology, Vol. 7, pp. 257-262, published by Interscience Publishers, Inc. (1951) or in U.S. Pat. No. 1,922,459. The alkylene oxides may be added to the initiator compound, individually, sequentially one after the other to form blocks, or in mixture to form a heteric polyether. The polyoxyalkylene polyether polyols may have either primary or secondary hydroxyl groups.

The polyoxyalkylene polyether polyols may be aromatic amine-initiated or aliphatic amine-initiated polyoxyalkylene polyether polyols. The amine-initiated polyols may be polyether polyols terminated with a secondary hydroxyl group through addition of, for example, ethylene oxide as the terminal block. It is preferred that the amine-initiated polyols contain 50 parts by weight or more, and up to 100 parts by weight, of secondary hydroxyl group forming alkylene oxides, such as polyoxyethylene groups, based on the weight of all oxyalkylene groups. This amount can be achieved by adding 50 parts by weight or more of the secondary hydroxyl group forming alkylene oxides to the initiator molecule in the course of manufacturing the polyol.

As described above, suitable initiator compounds for the polyol include primary or secondary amines. These would include, for aromatic amine-initiated polyether polyols, the aromatic amines such as aniline, N-alkylphenylene-diamines, 2,4′-, 2,2′-, and 4,4′-methylenedianiline, 2,6- or 2,4-toluenediamine, vicinal toluenediamines, o-chloro-aniline, p-aminoaniline, 1,5-diaminonaphthalene, methylene dianiline, the various condensation products of aniline and formaldehyde, and the isomeric diaminotoluenes, with preference given to vicinal toluenediamines.

For aliphatic amine-initiated polyols, any aliphatic amine, whether branched or unbranched, substituted or unsubstituted, saturated or unsaturated, may be used. These would include, as examples, mono-, di-, and trialkanolamines, such as monoethanolamine, methylamine, triisopropanolamine; and polyamines such as ethylene diamine, propylene diamine, diethylenetriamine; or 1,3-diaminopropane, 1,3-diaminobutane, and 1,4-diaminobutane. Preferable aliphatic amines include any of the diamines and triamines, most preferably, the diamines.

The polyoxyalkylene polyether polyols may generally be prepared by polymerizing alkylene oxides with polyhydric amines. Any suitable alkylene oxide may be used such as ethylene oxide, propylene oxide, butylene oxide, amylene oxide, and combinations of these oxides so long as the polyol, after preparation, comprises the ethylene oxide cap of at least 15 parts by weight based on the total weight of alkylene oxides in the polyol. The polyoxyalkylene polyether polyols may be prepared from other starting materials such as tetrahydrofuran and alkylene oxide-tetrahydrofuran mixtures; epihalohydrins such as epichlorohydrin; as well as aralkylene oxides such as styrene oxide.

Also suitable are polymer modified polyols, in particular, the so-called graft polyols. Graft polyols are well known to the art and are prepared by the in situ polymerization of one or more vinyl monomers, preferably acrylonitrile and styrene, in the presence of a polyether polyol, particularly polyols containing a minor amount of natural or induced unsaturation. Methods of preparing such graft polyols may be found in columns 1-5 and in the Examples of U.S. Pat. No. 3,652,639; in columns 1-6 and in the Examples of U.S. Pat. No. 3,823,201; in columns 2-8 and in the Examples of U.S. Pat. No. 4,690,956: and in U.S. Pat. No. 4,524,157; all of which patents are herein incorporated by reference.

Non-graft polymer modified polyols are also suitable, for example, as those prepared by the reaction of a polyisocyanate with an alkanolamine in the presence of a polyether polyol as taught by U.S. Pat. Nos. 4,293,470; 4,296,213; and 4,374,209; dispersions of polyisocyanurates containing pendant urea groups as taught by U.S. Pat. No. 4,386,167; and polyisocyanurate dispersions also containing biuret linkages as taught by U.S. Pat. No. 4,359,541. Other polymer modified polyols may be prepared by the in situ size reduction of polymers until the particle size is less than 20 mm, preferably less than 10 mm.

Preferably, the resin component includes a plurality of polyols. If the resin component includes a plurality of polyols, then each polyol of the plurality preferably has a hydroxyl number of at least 28 mg KOH/gm and a nominal functionality of at least 2.0.

In one embodiment of the subject invention, the plurality of polyols includes a toluenediamine-initiated polyether polyol, referred to as a first polyol for descriptive purposes, having a hydroxyl number of from 350 to 450 mg KOH/gm and a nominal functionality of from 3.5 to 4.5, and a glycerin-initiated polyether polyol, referred to as a second polyol for descriptive purposes, having a hydroxyl number of from 30 to 200 mg KOH/gm and a nominal functionality of from 2.0 to 3.0. Preferably, in this blend of polyols, each polyol includes the EO cap of at least 15 parts by weight based on the total weight of alkylene oxides in the polyol. One suitable first polyol is commercially available as Pluracol® 735 from BASF Corporation. One suitable second polyol is commercially available as Pluracol® 816 from BASF Corporation.

In another embodiment, the isocyanate-reactive component is a polyamine. Preferably, the polyamine is selected from the group of aromatic and aliphatic polyamines, and mixtures thereof. The polyamine can also be a polyether or polyester polyamine. The polyamine is preferably selected from the group of di-functional and tri-functional polyamines and combinations thereof. More specifically, the polyamine is most preferably selected from the group of polyoxyalkylene amines, polyoxyalkylene diamines, and polyoxyalkylene triamines.

Preferably, the resin component includes a plurality of polyamines. In other embodiments, the resin component includes a mixture of polyamines and polyols. If the resin component includes a plurality of polyamines and/or polyols, then each polyamine and/or polyol of the plurality preferably has a hydroxyl number of at least 28 mg KOH/gm and a nominal functionality of at least 2.0.

In addition to the isocyanate-reactive component, or components, the resin component may further comprise the reaction product of a catalyst. It is to be understood that the catalyst is not required for reaction between the isocyanate-reactive component of the resin component and the isocyanate component. However, if the catalyst is included, the catalyst comprises an amine-based catalyst, a tin-based catalyst, or combination thereof, and is present in the resin component in an amount from 1 to 3 parts by weight based on the total weight of the resin component. General examples of amine- and tin-based catalysts are included below.

Preferred catalysts include, but are not limited to triethylenediamine (TEDA), 1-methyl imidazole (NIMA), and dimethylbis[(1-oxoneodecyl)oxy]-stannane, which is also known as dimethyl tin dilaurate (Fomrez UL-28). TEDA is commercially available as DABCO 33-LV® from Air Products and Chemicals, Inc., Allentown, Pa.

Other examples of suitable catalysts include organometallic catalysts, preferably organotin catalysts, although it is possible to employ metals such as lead, titanium, copper, mercury, cobalt, nickel, iron, vanadium, antimony, and manganese. Suitable organometallic catalysts, exemplified here by tin as the metal, are represented by the formula: RₙSn[X—R¹-y]₂, wherein R is a C₁-C₈ alkyl or aryl group, R¹ is a C₀-C₁₈ methylene group optionally substituted or branched with a C₁-C₄ alkyl group, Y is hydrogen or a hydroxyl group, preferably hydrogen, X is methylene, an —S—, an —SR²COO—, —SOOC—, an —O₃S—, or an —OOC— group wherein R² is a C₁-C₄ alkyl, n is 0 or 2, provided that R¹ is C₀ only when X is a methylene group.

Specific examples are tin (II) acetate, tin (II) octanoate, tin (II) ethylhexanoate and tin (II) laurate; and dialkyl (1-8C) tin (IV) salts of organic carboxylic acids having 1-32 carbon atoms, preferably 1-20 carbon atoms, e.g., diethyltin diacetate, dibutyltin diacetate, dibutyltin diacetate, dibutyltin dilaurate, dibutyltin maleate, dihexyltin diacetate, and dioctyltin diacetate. Other suitable organotin catalysts are organotin alkoxides and mono or polyalkyl (1-8C) tin (IV) salts of inorganic compounds such as butyltin trichloride, dimethyl- and diethyl- and dibutyl- and dioctyl- and diphenyl- tin oxide, dibutyltin dibutoxide, di(2-ethylhexyl) tin oxide, dibutyltin dichloride, and dioctyltin dioxide. Further suitable catalysts are tin catalysts with tin-sulfur bonds which are resistant to hydrolysis, such as dialkyl (1-20C) tin dimercaptides, including dimethyl-, dibutyl-, and dioctyl- tin dimercaptides.

As for catalysis of the reaction between the isocyanate-reactive component in the resin component and the isocyanate component, in addition to the catalysts already identified above, tertiary amines may also be used to promote urethane linkage formation, in the embodiment wherein the isocyanate-reactive component is a polyol, in the second layer. In addition to TEDA, these amines include triethylamine, 3-methoxypropyldimethylamine, tributylamine, dimethylbenzylamine, N-methyl-, N-ethyl- and N-cyclohexylmorpholine, N,N,N′,N′-tetramethylethylenediamine, N,N,N′,N′-tetramethylbutanediamine or -hexanediamine, N,N,N′-trimethyl isopropyl propylenediamine, pentamethyldiethylenetriamine, tetramethyldiaminoethyl ether, bis(dimethylaminopropyl)urea, dimethylpiperazine, 1-methyl4-dimethylaminoethyl-piperazine, 1,2-dimethylimidazole, 1-azabicylo[3.3.0]octane and preferably 1,4-diazabicylol[2.2.2]octane, and alkanolamine compounds, such as triethanolamine, triisopropanolamine, N-methyl- and N-ethyldiethanolamine and dimethylethanolamine.

The resin component may further comprise a compatibilizing agent for improving the stability of the supplemental cross-linking agent in the resin component. In one embodiment, the compatibilizing agent includes an aliphatic chain portion and a cyclic portion. Preferably, the compatibilizing agent is an aliphatic chain including a phenolic portion. In a preferred embodiment, the compatibilizing agent is an alkoxylated bisphenol-A. An example of an alkoxylated bisphenol-A suitable for the subject invention is ethoxylated bisphenol-A commercially available under the product name Macol® RD209 E UN from BASF Corporation. Preferably, the compatibilizing agent is present in an amount of from 18 to 30 parts by weight based on the total weight of the resin component.

The resin component may also further comprise an additive or additives. If included, the additive is selected from the group consisting of surfactants, flame retardants, water scavengers, anti-foam agents, surfactants, UW performance enhancers, hindered amine light stabilizers, thixotropic agents (both reactive and non-reactive), chain extenders, and combinations thereof. Other suitable additives include, but are not limited to, cell regulators, hydrolysis-protection agents, fungistatic and bacteriostatic substances, dispersing agents, adhesion promoters, and appearance enhancing agents. Each of these additives serves a specific function, or functions, within the resin component that are known to those skilled in the art.

Further details on the other conventional assistants and additives mentioned above can be obtained from the specialist literature, for example, from the monograph by J. H. Saunders and K. C. Frisch, High Polymers, Volume XVI, Polyurethanes, Parts 1 and 2, Interscience Publishers 1962 and 1964, respectively, or Kunststoff-Handbuch, Polyurethane, Volume VII, Carl-Hanser-Verlag, Munich, Vienna, 1st and 2nd Editions, 1966 and 1983; incorporated herein by reference.

As initially described above, the resin component reacts with the isocyanate component to form the second layer. Preferably, the isocyanate component is selected from the group of diphenylmethane diisocyanate, polymeric methylene diphenyl diisocyanate, liquid carbodiimide modified 4,4′-diphenylmethane diisocyanate, and combinations thereof. Preferred isocyanate components include, but are not limited to, Lupranate® M20S, Lupranate® MM103, and Lupranate® MI. All of these isocyanates are commercially available from BASF Corporation. The isocyanate component may comprise a plurality of isocyanates. That is, a blend of at least two isocyanates may be utilized for reaction with the resin component to form the second layer.

It is to be understood that the isocyanate component may also be a pre-polymer. That is, the isocyanate component may be an isocyanate-terminated pre-polymer comprising the reaction product of a stoichiometric excess of an isocyanate and a polyol. Preferably, the polyol is present in an amount of from 5 to 75 parts by weight, more preferably from 30 to 50 parts by weight, based on the total weight of the isocyanate component. The polyol may be selected from any of the aforementioned polyols.

More specific examples of polyisocyanates and isocyanate pre-polymers include aromatic, polyisocyanates containing urethane groups and having an NCO content of from 20 to 35 parts by weight, preferably from 23 to 32 parts by weight, based on the total weight of the isocyanate component, e.g. with low molecular weight diols, triols, dialkylene glycols, trialkylene glycols, or polyoxyalkylene glycols with a molecular weight of up to 6000; modified 4,4′-diphenylmethane diisocyanate or 2,4- and 2,6-toluene diisocyanate, where examples of di- and polyoxyalkylene glycols that may be used individually or as mixtures include diethylene glycol, dipropylene glycol, polyoxyethylene glycol, polyoxypropylene glycol, polyoxyethylene glycol, polyoxypropylene glycol, and polyoxypropylene polyoxyethylene glycols or -triols. Prepolymers containing NCO groups and produced from the polyester polyols and/or preferably polyether polyols described herein are also suitable. 4,4′-diphenylmethane diisocyanate, mixtures of 2,4′- and 4,4′-diphenylmethane diisocyanate, and 2,4,- and/or 2,6-toluene diisocyanates are also suitable.

Other suitable isocyanate components include, but are not limited to, conventional aliphatic, cycloaliphatic, araliphatic and aromatic isocyanates. Specific examples include: alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate, 1,6-hexamethylene diisocyanate; cycloaliphatic diisocyanates such as 1,3- and 1,4-cyclohexane diisocyanate as well as any mixtures of these isomers, 1-isocyanato-3,3,5-trimethyl-5-isocyanatomethylcyclohexane (isophorone diisocyanate), 2,4- and 2,6-hexahydrotoluene diisocyanate as well as the corresponding isomeric mixtures, 4,4′- 2,2′-, and 2,4′-dicyclohexylmethane diisocyanate as well as the corresponding isomeric mixtures and aromatic diisocyanates and polyisocyanates such as 2,4- and 2,6-toluene diisocyanate and the corresponding isomeric mixtures 4,4′-, 2,4′-, and 2,2′-diphenylmethane diisocyanate and the corresponding isomeric mixtures, mixtures of 4,4′-, 2,4′-, and 2,2-diphenylmethane diisocyanates and polyphenylene polymethylene polyisocyanates (crude MDI), as well as mixtures of crude MDI and toluene diisocyanates. The organic di- and polyisocyanates can be used individually or in the form of mixtures.

Additionally, so-called modified multivalent isocyanates, i.e., products obtained by the partial chemical reaction of organic diisocyanates and/or polyisocyanates may be used. Examples include diisocyanates and/or polyisocyanates containing ester groups, urea groups, biuret groups, allophanate groups, carbodiimide groups, isocyanurate groups, and/or urethane groups.

Furthermore, in addition to the preferred liquid carbodiimide modified 4,4′-diphenylmethane diisocyanate as set forth above, other liquid polyisocyanates containing carbodiimide groups are also suitable, e.g. those based on 2,4′- and/or 2,2′-diphenylmethane diisocyanate and/or 2,4′- and/or 2,6-toluene diisocyanate. The modified polyisocyanates may optionally be mixed together or mixed with umnodified organic polyisocyanates such as 2,4′- and 4,4′-diphenylmethane diisocyanate, polymeric MDI, 2,4′- and/or 2,6-toluene diisocyanate.

The volume ratio of the isocyanate component to the resin component is from 1:1 to 3:1. In a preferred embodiment, the volume ratio is 1:1. The isocyanate component has a nominal isocyanate functionality of from 2.0 to 3.0. Such functionalities provide for a greater cross-linking density which improves the overall dimensional stability of the composite structure. The isocyanate component utilized to form the second layer of the subject invention has a NCO content of from 15 to 35, more preferably from 29 to 34, parts by weight based on the total weight of the isocyanate component. The isocyanate component and the resin component are reacted in such amounts that the isocyanate index, defined as the number of equivalents of NCO groups divided by the total number of isocyanate reactive hydrogen atom equivalents multiplied by 100, ranges from approximately 100 to 200, preferably from approximately 110 to 150.

The completed composite structure of the subject invention has a heat distortion temperature of from 175° F. to 225° F. more preferably from 190° F. to 210° F. when tested according to ASTM D648-01 standards. The heat distortion temperatures in the stated ranges are sufficient to withstand temperatures that the composite structure is ordinary subjected to.

The following examples, illustrating the composition of the first layer and the second layer are intended to illustrate and not to limit the invention. The amounts set forth in these examples are by weight, unless otherwise indicated.

### EXAMPLES

| Layer | Component | Ex. A | Ex. B | Ex. C | Ex. D | Ex. E |
|---|---|---|---|---|---|---|
| First Layer | Styrenated Polyester | 100.00 | 100.00 | 100.00 | 100.00 | 100.00 |
| | Total | 100.00 | 100.00 | 100.00 | 100.00 | 100.00 |
| Second Layer | | | | | | |
| Resin | Polyamine A | 40.00 | 40.00 | 18.00 | 0.00 | 0.00 |
| Component | Polyamine B | 0.00 | 0.00 | 0.00 | 18.00 | 25.00 |
| | Polyol A | 0.00 | 0.00 | 0.00 | 0.00 | 0.00 |
| | Polyol B | 0.00 | 0.00 | 0.00 | 0.00 | 0.00 |
| | Polyol C | 0.00 | 0.00 | 0.00 | 0.00 | 0.00 |
| | Polyol D | 0.00 | 0.00 | 0.00 | 0.00 | 0.00 |
| | Polyol E | 0.00 | 0.00 | 0.00 | 0.00 | 0.00 |
| | Supplemental Cross- | 19.00 | 18.00 | 18.00 | 18.00 | 15.00 |
| | Linker A | | | | | |
| | Supplemental Cross- | 0.00 | 0.00 | 0.00 | 0.00 | 0.00 |
| | Linker B | | | | | |
| | Supplemental Cross- | 0.00 | 0.00 | 0.00 | 0.00 | 0.00 |
| | Linker C | | | | | |
| | Supplemental Cross- | 8.00 | 8.00 | 10.00 | 10.00 | 16.00 |
| | Linker D | | | | | |
| | Supplemental Cross- | 0.00 | 0.00 | 0.00 | 0.00 | 0.00 |
| | Linker E | | | | | |
| | Supplemental Cross- | 0.00 | 0.00 | 0.00 | 0.00 | 0.00 |
| | Linker F | | | | | |
| | Catalyst | 0.00 | 0.00 | 0.00 | 0.00 | 0.00 |
| | Additive A | 0.00 | 0.00 | 0.00 | 0.00 | 0.00 |
| | Additive B | 2.00 | 2.00 | 4.00 | 4.00 | 0.00 |
| | Additive C | 1.00 | 2.00 | 0.00 | 0.00 | 4.00 |
| | Additive D | 0.00 | 0.00 | 0.00 | 0.00 | 0.00 |
| | Additive E | 0.00 | 0.00 | 0.00 | 0.00 | 0.00 |
| | Filler A | 30.00 | 0.00 | 50.00 | 0.00 | 40.00 |
| | Filler B | 0.00 | 30.00 | 0.00 | 50.00 | 0.00 |
| | Total | 100.00 | 100.00 | 100.00 | 100.00 | 100.00 |
| Isocyanate | Isocyanate A | 0.00 | 0.00 | 0.00 | 0.00 | 45.00 |
| Component | Isocyanate B | 45.00 | 45.00 | 45.00 | 45.00 | 0.00 |
| | Isocyanate C | 0.00 | 0.00 | 0.00 | 0.00 | 0.00 |
| | Polyol A | 45.00 | 45.00 | 45.00 | 45.00 | 45.00 |
| | Additive D | 10.00 | 10.00 | 10.00 | 10.00 | 10.00 |
| | NCO % | 15.50 | 15.50 | 15.50 | 15.50 | 15.50 |
| | Total | 100.00 | 100.00 | 100.00 | 100.00 | 100.00 |
| Mix Ratio (R:T) | By weight | 48:52 | 52:48 | 53:47 | 54:46 | 53:47 |
| @ 100 index | By volume | 51:49 | 48:52 | 47:53 | 56:44 | 51:49 |

| Layer | Component | Ex. F | Ex. G | Ex. H | Ex. I | Ex. J |
|---|---|---|---|---|---|---|
| First Layer | Styrenated Polyester | 100.00 | 100.00 | 100.00 | 100.00 | 100.00 |
| | Total | 100.00 | 100.00 | 100.00 | 100.00 | 100.00 |
| Second Layer | | | | | | |
| Resin | Polyamine A | 36.00 | 0.00 | 30.00 | 0.00 | 0.00 |
| Component | Polyamine B | 0.00 | 31.00 | 0.00 | 25.00 | 31.00 |
| | Polyol A | 0.00 | 0.00 | 0.00 | 0.00 | 0.00 |
| | Polyol B | 0.00 | 0.00 | 0.00 | 0.00 | 0.00 |
| | Polyol C | 0.00 | 0.00 | 0.00 | 0.00 | 0.00 |
| | Polyol D | 0.00 | 0.00 | 0.00 | 0.00 | 0.00 |
| | Polyol E | 0.00 | 0.00 | 0.00 | 0.00 | 0.00 |
| | Supplemental Cross- | 0.00 | 0.00 | 10.00 | 8.00 | 12.00 |
| | Linker A | | | | | |
| | Supplemental Cross- | 0.00 | 0.00 | 21.00 | 28.00 | 0.00 |
| | Linker B | | | | | |
| | Supplemental Cross- | 20.00 | 25.00 | 0.00 | 0.00 | 0.00 |
| | Linker C | | | | | |
| | Supplemental Cross- | 0.00 | 0.00 | 0.00 | 0.00 | 0.00 |
| | Linker D | | | | | |
| | Supplemental Cross- | 0.00 | 0.00 | 0.00 | 0.00 | 0.00 |
| | Linker E | | | | | |
| | Supplemental Cross- | 0.00 | 0.00 | 0.00 | 0.00 | 0.00 |
| | Linker F | | | | | |
| | Catalyst | 0.00 | 0.00 | 0.00 | 0.00 | 0.00 |
| | Additive A | 0.00 | 0.00 | 0.00 | 0.00 | 18.00 |
| | Additive B | 0.00 | 0.00 | 0.00 | 0.00 | 0.00 |
| | Additive C | 4.00 | 4.00 | 4.00 | 4.00 | 4.00 |
| | Additive D | 0.00 | 0.00 | 0.00 | 0.00 | 0.00 |
| | Additive E | 0.00 | 0.00 | 0.00 | 0.00 | 0.00 |
| | Filler A | 40.00 | 40.00 | 35.00 | 35.00 | 35.00 |
| | Filler B | 0.00 | 0.00 | 0.00 | 0.00 | 0.00 |
| | Total | 100.00 | 100.00 | 100.00 | 100.00 | 100.00 |
| Isocyanate | Isocyanate A | 45.00 | 45.00 | 45.00 | 45.00 | 45.00 |
| Component | Isocyanate B | 0.00 | 0.00 | 0.00 | 0.00 | 0.00 |
| | Isocyanate C | 0.00 | 0.00 | 0.00 | 0.00 | 0.00 |
| | Polyol A | 45.00 | 45.00 | 45.00 | 45.00 | 45.00 |
| | Additive D | 10.00 | 10.00 | 10.00 | 10.00 | 10.00 |
| | NCO % | 15.50 | 15.50 | 15.50 | 15.50 | 15.50 |
| | Total | 100.00 | 100.00 | 100.00 | 100.00 | 100.00 |
| Mix Ratio (R:T) | By weight | 67:33 | 65:35 | 49:51 | 47:53 | 60:40 |
| @ 100 index | By volume | 37:63 | 38:62 | 56:44 | 58:42 | 44:56 |

| Layer | Component | Ex. K | Ex. L | Ex. M | Ex. N | Ex. O |
|---|---|---|---|---|---|---|
| First Layer | Styrenated Polyester | 100.00 | 100.00 | 100.00 | 100.00 | 100.00 |
| | Total | 100.00 | 100.00 | 100.00 | 100.00 | 100.00 |
| Second Layer | | | | | | |
| Resin | Polyamine A | 0.00 | 0.00 | 0.00 | 0.00 | 0.00 |
| Component | Polyamine B | 0.00 | 0.00 | 0.00 | 0.00 | 0.00 |
| | Polyol A | 0.00 | 0.00 | 0.00 | 0.00 | 0.00 |
| | Polyol B | 35.00 | 0.00 | 0.00 | 23.00 | 0.00 |
| | Polyol C | 0.00 | 25.00 | 0.00 | 0.00 | 0.00 |
| | Polyol D | 0.00 | 10.00 | 0.00 | 0.00 | 0.00 |
| | Polyol E | 0.00 | 0.00 | 23.00 | 0.00 | 23.00 |
| | Supplemental Cross- | 0.00 | 0.00 | 0.00 | 0.00 | 0.00 |
| | Linker A | | | | | |
| | Supplemental Cross- | 0.00 | 0.00 | 0.00 | 0.00 | 0.00 |
| | Linker B | | | | | |
| | Supplemental Cross- | 0.00 | 0.00 | 0.00 | 0.00 | 0.00 |
| | Linker C | | | | | |
| | Supplemental Cross- | 0.00 | 0.00 | 0.00 | 0.00 | 0.00 |
| | Linker D | | | | | |
| | Supplemental Cross- | 30.00 | 30.00 | 30.00 | 0.00 | 0.00 |
| | Linker E | | | | | |
| | Supplemental Cross- | 0.00 | 0.00 | 0.00 | 35.00 | 30.00 |
| | Linker F | | | | | |
| | Catalyst | 1.50 | 1.50 | 2.50 | 2.50 | 2.50 |
| | Additive A | 0.00 | 0.00 | 0.00 | 0.00 | 0.00 |
| | Additive B | 3.00 | 3.00 | 4.00 | 4.00 | 4.00 |
| | Additive C | 0.00 | 0.00 | 0.00 | 0.00 | 0.00 |
| | Additive D | 0.50 | 0.50 | 0.50 | 0.50 | 0.50 |
| | Additive E | 0.00 | 0.00 | 0.00 | 0.00 | 0.00 |
| | Filler A | 30.00 | 0.00 | 0.00 | 35.00 | 40.00 |
| | Filler B | 0.00 | 30.00 | 40.00 | 0.00 | 0.00 |
| | Total | 100.00 | 100.00 | 100.00 | 100.00 | 100.00 |
| Isocyanate | Isocyanate A | 0.00 | 0.00 | 0.00 | 100.00 | 100.00 |
| Component | Isocyanate B | 0.00 | 0.00 | 0.00 | 0.00 | 0.00 |
| | Isocyanate C | 100.00 | 100.00 | 100.00 | 0.00 | 0.00 |
| | Polyol A | 0.00 | 0.00 | 0.00 | 0.00 | 0.00 |
| | Additive D | 0.00 | 0.00 | 0.00 | 0.00 | 0.00 |
| | NCO % | 31.50 | 31.50 | 31.50 | 29.50 | 29.50 |
| | Total | 100.00 | 100.00 | 100.00 | 100.00 | 100.00 |
| Mix Ratio (R:T) | By weight | 51:49 | 48:52 | 48:52 | 46:54 | 45:55 |
| @ 100 index | By volume | 50:50 | 45:55 | 42:48 | 44:56 | 42:58 |

Styrenated Polyester is Vipel™ F737-FB Series Polyester Resin (formerly E737-FBL).

Polyamine A is a propylene glycol-initiated difunctional primary amine having a hydroxyl number of approximately 112 mg KOH/gm and a nominal functionality of approximately 2.0. (BASF Corporation)

Polyamine B is a polyether triamine having a hydroxyl number of from 28 to 32 mg KOH/gm and a nominal functionality of approximately 3.0. (BASF Corporation)

Polyol A is a glycerin-initiated polyether polyol having a hydroxyl number of from 34 to 36 mg KOH/gm and a nominal functionality of from 2.5 to 3.0. (BASF Corporation)

Polyol B is a polyethylene glycol having a hydroxyl number of approximately 187.5 mg KOH/gm and a nominal functionality of approximately 2.0. (BASF Corporation)

Polyol C is a toluene diamine-initiated polyether polyol having a hydroxyl number of from 438 to 465 mg KOH/gm and a nominal functionality of approximately 4.0. (BASF Corporation)

Polyol D is a glycerin-initiated polyether polyol having a hydroxyl number of from 34 to 36 mg KOH/gm and a nominal functionality of approximately 2.6. (BASF Corporation)

Polyol E is a monoethanolamine-initiated polyether polyol having a hydroxyl number of approximately 503 mg KOH/gm and a nominal functionality of approximately 3.0. (BASF Corporation)

Supplemental Cross-Linker A is diethyltoluenediamine (DETDA).

Supplemental Cross-Linker B is dimethylthiotoluenediamine (DMTDA).

Supplemental Cross-Linker C is Clearlink® 1000. (Dorf Ketal)

Supplemental Cross-Linker D is Unilink® 4200. (Dorf Ketal)

Supplemental Cross-Linker E is diethylene glycol.

Supplemental Cross-Linker F is 1,4-butane diol.

Catalyst is 33% triethylenediamine (TEDA) in propylene glycol (Air Products and Chemicals, Inc.)

Additive A is a 100% active un-neutralized ethoxylated bisphenol A compatibilizing agent commercially available as Macol® RD 209 E UN. (BASF Corporation)

Additive B is a sodium/potassium aluminasilicate water scavenger.

Additive C is an oxazolidine water scavenger.

Additive D is a defoamer of polysiloxane in Diisobutylketone commercially available as BYK®-066. (BYK-Chemie)

Additive E is TCPP flame retardant. (Great Lakes Chemical)

Filler A is silica commercially available as Imsil® A-30 Silica. (Unimin Corp.)

Filler B is titanium dioxide.

Isocyanate A is a liquid carbodiimide modified 4,4′-diphenylmethane diisocyanate with a NCO content of approximately 29.5 parts by weight. (BASF Corp.)

Isocyanate B is diphenylmethane diisocyanate having a functionality of approximately 2.0 and a NCO content of approximately 33.5 parts by weight. (BASF Corp.)

Isocyanate C is a PMDI, a polymethylene polyphenyl polyisocyanate, with a functionality of approximately 2.7 and a NCO content for 31.5 parts by weight. (BASF Corp.)

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

1. A composite structure comprising:
(A) a first layer comprising a styrenated polyester wherein said first layer is a show surface of said composite structure; and
(B) a second layer comprising:
(i) a filler, and
(ii) the reaction product of:
(a) an isocyanate component, and
(b) a resin component comprising:
(I) an isocyanate-reactive component, and
(II) a supplemental cross-linking agent present in an amount of at least 10 parts by weight based on the total weight of said resin component.

2. A composite structure as set forth in claim 1 wherein said supplemental cross-linking agent is present in an amount of from 10 to 50 parts by weight based on the total weight of said resin component.

3. A composite structure as set forth in claim 1 wherein said supplemental cross-linking agent comprises a hydroxy-functional cross-linking agent.

4. A composite structure as set forth in claim 3 wherein said hydroxy-functional cross-linking agent is selected from the group of ethylene glycols, propylene glycols, butylene glycols, and combinations thereof.

5. A composite structure as set forth in claim 1 wherein said supplemental cross-linking agent comprises an amine-functional cross-linking agent.

6. A composite structure as set forth in claim 5 wherein amine-functional cross-linking agent is selected from the group of aromatic diamines, aliphatic diamines, and combinations thereof.

7. A composite structure as set forth in claim 1 wherein said isocyanate component is selected from the group of diphenylmethane diisocyanate, polymeric methylene diphenyl diisocyanate, liquid carbodiimide modified 4,4′-diphenylmethane diisocyanate, and combinations thereof.

8. A composite structure as set forth in claim 1 wherein said isocyanate component has a nominal isocyanate functionality of from 2.0 to 3.0.

9. A composite structure as set forth in claim 1 wherein said isocyanate component has an NCO content of from 15 to 35 parts by weight based on the total weight of said isocyanate component.

10. A composite structure as set forth in claim 1 wherein said isocyanate component comprises the reaction product of a polyol and a stoichiometric excess of an isocyanate.

11. A composite structure as set forth in claim 10 wherein said polyol is present in an amount of from 5 to 75 parts by weight based on the total weight of said isocyanate component.

12. A composite structure as set forth in claim 1 wherein the volume ratio of said isocyanate component to said resin component is from 1:1 to 3:1.

13. A composite structure as set forth in claim 1 wherein said isocyanate-reactive component is present in an amount of from 18 to 70 parts by weight based on the total weight of said resin component.

14. A composite structure as set forth in claim 1 wherein said isocyanate-reactive component comprises a polyol.

15. A composite structure as set forth in claim 14 wherein said polyol comprises an adduct having 100% ethylene oxide based on the total weight of alkylene oxides in said polyol.

16. A composite structure as set forth in claim 14 wherein said polyol comprises a cap having ethylene oxide in an amount of at least 15 parts by weight based on the total weight of alkylene oxides in said polyol.

17. A composite structure as set forth in claim 14 wherein said polyol comprises a plurality of polyols having a hydroxyl number of at least 28 mg KOH/gm and a cap having ethylene oxide in an amount of at least 15 parts by weight based on the total weight alkylene oxides in said polyol.

18. A composite structure as set forth in claim 14 wherein said filler is present in an amount of at least 30 parts by weight based on the total weight of said resin component.

19. A composite structure as set forth in claim 18 wherein said polyol comprises a cap having ethylene oxide in an amount of at least 45 parts by weight based on the total weight of alkylene oxides in said polyol.

20. A composite structure as set forth in claim 1 wherein said isocyanate-reactive component comprises a polyamine.

21. A composite structure as set forth in claim 20 wherein said polyamine is selected from the group of di-functional and tri-functional polyamines and combinations thereof.

22. A composite structure as set forth in claim 1 wherein said filler is present in an amount of from 1 to 70 parts by weight based on the total weight of said resin component.

23. A composite structure as set forth in claim 1 wherein said filler is selected from the group of silica, aluminum hydroxide, calcium carbonate, sand, and combinations thereof.

24. A composite structure as set forth in claim 1 wherein said resin component further comprises a phenol in an amount of from 18 to 30 parts by weight based on the total weight of said resin component.

25. A composite structure as set forth in claim 24 wherein said phenol comprises a bisphenol A alkoxylate.

26. A composite structure as set forth in claim 1 wherein said resin component further comprises a catalyst in an amount from 1 to 3 parts by weight based on the total weight of said resin component.

27. A composite structure as set forth in claim 26 wherein said catalyst comprises an amine-based catalyst, a tin-based catalyst, or combination thereof.

28. A composite structure as set forth in claim 1 wherein said second layer further comprises at least one additive selected from the group of surfactants, flame retardants, moisture scavengers, anti-foam agents, UV performance enhancers, hindered amine light stabilizers, antioxidants, pigments, thixotropic agents, and combinations thereof.

29. A composite structure as set forth in claim 1 having a heat distortion temperature of from 175° F. to 225° F.

30. A composite structure as set forth in claim 1 wherein said second layer has a gel time of from 0.5 to 6 minutes.

31. A resin component comprising:
a filler;
an isocyanate-reactive component; and
a supplemental cross-linking agent present in an amount of at least 10 parts by weight based on the total weight of said resin component.

32. A resin component as set forth in claim 31 wherein said supplemental cross-linking agent is present in an amount of from 10 to 50 parts by weight based on the total weight of said resin component.

33. A resin component as set forth in claim 31 wherein said supplemental cross-linking agent comprises a hydroxy-functional cross-linking agent.

34. A composite structure as set forth in claim 33 wherein said hydroxy-functional cross-linking agent is selected from the group of ethylene glycols, propylene glycols, butylene glycols, and combinations thereof.

35. A resin component as set forth in claim 31 wherein said supplemental cross-linking agent comprises an amine-functional cross-linking agent.

36. A resin component as set forth in claim 35 wherein said amine-functional cross-linking agent is selected from the group of aromatic diamines, aliphatic diamines, and combinations thereof.

37. A resin component as set forth in claim 31 wherein said isocyanate-reactive component is present in an amount of from 18 to 70 parts by weight based on the total weight of said resin component.

38. A resin component as set forth in claim 31 wherein said isocyanate-reactive component comprises the reaction product of a polyol and a stoichiometric excess of an isocyanate.

39. A resin component as set forth in claim 38 wherein said polyol comprises an adduct having 100% ethylene oxide based on the total weight of alkylene oxides in the polyol.

40. A resin component as set forth in claim 38 wherein said polyol comprises a cap having ethylene oxide in an amount of at least 15 parts by weight based on the total weight of alkylene oxides in said polyol.

41. A resin component as set forth in claim 38 wherein said polyol comprises a plurality of polyols having a hydroxyl number of at least 28 mg KOH/gm and a cap having ethylene oxide in an amount of at least 15 parts by weight based on the total weight of alkylene oxides in said polyol.

42. A resin component as set forth in claim 38 wherein said filler is present in an amount of at least 30 parts by weight based on the total weight of said resin component.

43. A resin component as set forth in claim 42 wherein said polyol comprises a cap having ethylene oxide in an amount of at least 45 parts by weight based on the total weight of alkylene oxides in said polyol.

44. A resin component as set forth in claim 31 wherein said isocyanate-reactive component comprises a polyamine.

45. A resin component as set forth in claim 44 wherein said polyamine is selected from the group of di-functional and tri-functional polyamines and combinations thereof.

46. A resin component as set forth in claim 31 wherein said filler is present in an amount of from 1 to 70 parts by weight based on the total weight of said resin component.

47. A resin component as set forth in claim 31 wherein said filler is selected from the group of silica, aluminum hydroxide, calcium carbonate, sand, and combinations thereof.

48. A resin component as set forth in claim 31 wherein said resin component further comprises a phenol in an amount of from 18 to 30 parts by weight based on the total weight of said resin component.

49. A resin component as set forth in claim 48 wherein said phenol comprises a bisphenol A alkoxylate.

50. A resin component as set forth in claim 31 wherein said resin component further comprises a catalyst in an amount of from 1 to 3 parts by weight based on the total weight of said resin component.

51. A resin component as set forth in claim 50 wherein said catalyst comprises an amine-based catalyst, a tin-based catalyst, or combination thereof.

52. A resin component as set forth in claim 31 further comprising at least one additive selected from the group of surfactants, flame retardants, moisture scavengers, anti-foam agents, UV performance enhancers, hindered amine light stabilizers, antioxidants, pigments, thixotropic agents, and combinations thereof.
